(19) United States
(12) Patent Application Publication
(10) Pub. No.: US 2008/0219319 A1
(43) Pub. Date: Sep. 11, 2008

(54) BIOLOGICAL PARAMETER MONITORING SYSTEM AND METHOD THEREFOR

(76) Inventor: Jay Buckalew, Sharpsburg, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/970,402

(22) Filed: Jan. 7, 2008

Related U.S. Application Data
(60) Provisional application No. 60/878,864, filed on Jan. 5, 2007.

(51) Int. Cl. G01K 7/01

(52) U.S. Cl. 374/178; 374/E07.035

(57) ABSTRACT

A system and method for monitoring biological parameters that allows a user to wirelessly monitor one or more biological parameters of one or more individuals, either continuously or periodically is disclosed. The system may send an alert when the biological parameter exceeds a predetermined threshold, and also provides information to the user about selected individuals or about components of the system.

### RELATED APPLICATIONS

The present nonprovisional U.S. patent application is related to, and hereby claims priority to and the full benefit of, provisional United States patent application entitled “Biological Parameter Monitoring System and Method Therefor”, having assigned Ser. No. 60/878,864, filed on Jan. 5, 2007 on behalf of Jay Buckalew, incorporated herein by reference.

### TECHNICAL FIELD

The present invention relates generally to measuring and testing, and more specifically, to a system and method for monitoring one or more biological parameter(s) of an individual, such as the temperature of an athlete during sports activity.

### BACKGROUND OF THE INVENTION

At all levels of sports competition and recreation, the safety of athletes is an aim that warrants serious concern and attention. While the dangers associated with some sports are obvious, and numerous safety devices and methods have been developed to address such obvious dangers, many dangers to which athletes are exposed are not so apparent. One such danger is that an athlete may become overheated during physical exertion in a competition or even a practice.

One sport where dehydration and heatstroke are particularly problematic is football. During games and practices, players can easily become overheated and suffer various symptoms, sometimes resulting in death. Despite the increase in cases of dehydration and heatstroke, and resulting efforts at prevention, there is still no reliable system or method to identify when an athlete is likely entering into a state of dehydration and/or heatstroke.

Given the popularity of sports and other activities where participants are at risk of suffering from overheating, and the gravity of the risk, such as death, it is clear that what is needed is a system and method for preventing athletes from becoming overheated, and for identifying individuals who may be in danger. It is desirable, therefore, to provide a biological parameter monitoring system and method for monitoring one or more biological parameters of an athlete, such as a temperature of the athlete.

### BRIEF SUMMARY OF THE INVENTION

Briefly described, in a preferred embodiment, the present invention overcomes the above-mentioned disadvantages and meets the recognized need for such a system by providing a biological parameter monitoring system comprising sensor means for generating at least one signal corresponding to a biological parameter, transmitter means operable with the sensor means for transmitting the signal(s), receiver means for receiving the signal(s) transmitted by the transmitter means, and interface means operable with the receiver means for displaying at least one of the signal(s), and an indication corresponding to the signal(s).

According to its major aspects and broadly stated, the present invention in its preferred form is a sensor device that is battery-powered and worn by an individual, such as mounted in a piece of an athlete's equipment, and that wirelessly transmits a signal to a monitoring device corresponding to at least one biological parameter of the individual, whereafter the monitoring means determines whether the biological parameter has exceeded a predetermined threshold and provides a warning when such predetermined threshold has been exceeded.

More specifically, the sensor device comprises a battery-powered, helmet-mounted thermistor in thermal communication with a wearer's skin and operable to output a signal having temperature information corresponding to a body temperature of the wearer, a microcontroller for receiving the output signal from the thermistor, and a radio-frequency transmitter operable to wirelessly transmit a signal to a radio-frequency receiver of a hand-held monitoring device via a printed or wire-trace antenna. The microcontroller preferably modifies an output signal of the thermistor to create the signal transmitted to the radio-frequency receiver, such as by adding identification information. As the helmet is likely to encounter substantial impact forces, the sensor device is preferably securely mounted in the helmet with adequate encapsulation, and may optionally be flexible and shock-resistant.

Each of a plurality of helmets may include a respective associated sensor device, and each associated sensor device may transmit one or more signal(s) to the receiver. As such, the identification information preferably allows the receiver to associate respective temperature information with the corresponding helmet and/or wearer. The hand-held monitoring device may include a database for associating the identification information and the helmet/wearer, as well as for storing additional information pertaining to the sensor device and/or the wearer. For example, the database may associate a sensor device with a uniform number, name, height, weight, or photograph of the wearer, or the like, to facilitate a user of the monitoring device, such as a coach, trainer, parent, or scout, associating received temperature information, or warning signals generated based thereon with the associated wearer.

Additionally, contact information (including emergency contact information), medical information, or the like may be stored in the database and associated with a respective sensor device or wearer, such that important information may be available when needed, such as in an emergency situation, whether or not detected by the sensor device. Specifically, when a predetermined event occurs, such as a detected value exceeding a pre-determined threshold, either once or more than a selected number of times, a warning signal may be generated by the monitoring device, and an indication of such warning signal, with or without information regarding the actual or estimated temperature information, may be displayed. The user may then access information associated with the wearer of the sensor device transmitting the warning signal in order to take appropriate action, such as assessing the physical condition of the wearer, treating a diagnosed condition, contacting a designated contact individual provided by the wearer, contacting emergency medical technicians, or the like.

Additionally, the monitoring device may be used to query each sensor device within a predetermined range in order to receive status information. Thus, a user, such as a coach, trainer, or parent, may determine a signal quality, battery level, absolute temperature value (based on the temperature information), warning status, or the like, for one or more sensor device (s). Such query may be performed for selected one or more selected sensor device(s), or for all sensor devices that are in range. Furthermore, the monitoring device and/or the sensor device may be operated in a “stand-by” mode, such as to conserve battery power, until the occurrence of one or more predetermined circumstance(s), when the monitoring device and/or the sensor device may automatically be switched to an “active mode”.

The present invention further overcomes the above-mentioned disadvantages and meets the recognized need by providing a method of monitoring a biological parameter including the steps of measuring a biological parameter, such as temperature, blood pressure, oxygen saturation, heart rate, respiratory rate, physical performance, location, and/or other biological parameter, generating a signal based on the measurement of the biological parameter, transmitting the signal to a remote receiver, and displaying at least one of the signal and an indication corresponding to the signal to monitor the biological parameter. The step of displaying preferably includes comparing at least a portion of the signal to a predetermined value, and selectively generating a warning signal when a difference between the signal and the predetermined value exceeds a predetermined threshold, wherein the indication corresponding to the signal is the warning signal. The predetermined value is preferably a mean value obtained from a plurality of signals.

Accordingly, a feature and advantage of the present invention is its ability to alert a user, such as a coach, trainer, supervisor, scout, parent, or other individual when an athlete is experiencing a predetermined condition or level of performance, such as when an athlete is becoming overheated.

Another feature and advantage of the present invention is its ability to directly measure a biological parameter of an athlete during a period of activity and wirelessly provide a signal corresponding to the measurement for monitoring.

Another feature and advantage of the present invention is its ability to simultaneously monitor one or more biological parameters of a plurality of athletes.

Yet another feature and advantage of the present invention is ability to provide pertinent information about a particular athlete, such as medical history or emergency contact information, at a time when the particular athlete suffers from overheating or another condition.

Another feature and advantage of the present invention is its ability to wirelessly monitor a biological parameter of an athlete and provide real-time indications corresponding to the monitored biological parameter.

These and other features and advantages of the invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of, and reference to, the following Figures, viewed in conjunction with the Detailed Description of the Preferred Embodiment referring thereto, in which like reference numbers throughout the various Figures designate like structure and in which:

FIG. 1 is a side cross-sectional view of a semiconductor sensor device of the present invention mounted in a football helmet;

FIG. 2 is a plan view of the semiconductor sensor device;

FIG. 3 is a front view of a hand-held interface unit of the present invention;

FIG. 4 is a screenshot of a computer program of the present invention illustrating a display for monitoring a plurality of athletes;

FIG. 5 is a screenshot illustrating a display indicating a non-communication warning;

FIG. 6 is a screenshot illustrating a display for viewing information corresponding to particular athletes and for viewing a status of the particular athlete and/or the semiconductor sensor device associated with the particular athlete;

FIG. 7 is a screenshot illustrating a display indicating a temperature warning; and

FIG. 8 is a screenshot of detailed information associated with a particular athlete as well as for displaying a status of the particular athlete and/or an associated semiconductor sensor device.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the drawings, specific terminology is employed for the sake of clarity. The invention, however, is not intended to be limited to the specific terminology so selected, and it is to be understood that each specific element includes all technical equivalents that operate in a similar manner to accomplish a similar purpose.

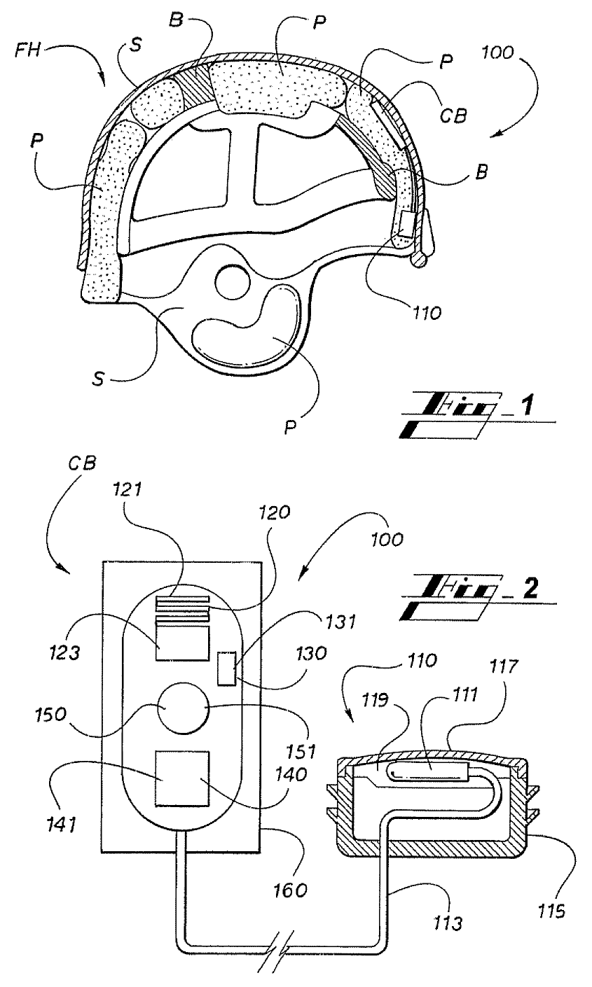

In that form of the preferred embodiment of the present invention chosen for purposes of illustration, FIGS. 1 and 2 show semiconductor sensor device 100 attached to football helmet FH. Semiconductor sensor device 100 is preferably removably attached to an interior surface of shell S, or to padding P, of football helmet FH, such as with an adhesive or a mechanical fastener, such as a clip, strap, tie, or a hook-and-loop fastener, or the like. Preferably, the structural integrity of football helmet FH is not altered by the attachment of semiconductor sensor device 100 or by the inclusion of such means thereon for the attachment of semiconductor sensor device 100. Preferably, a configuration of football helmet FH is not altered at all by the inclusion or attachment of semiconductor sensor device 100, although it is contemplated that football helmet FH may be modified to receive or include means for attaching semiconductor sensor device 100 or that football helmet FH may be designed or redesigned to include, integrally or otherwise, such attachment means when originally manufactured. Semiconductor sensor device 100 is preferably arranged on football helmet FH such that semiconductor sensor device 100 does not interfere with padding P, air bladder B, or other components of or attached to football helmet FH, and such that use of football helmet FH is not adversely affected. As illustrated, semiconductor sensor device 100 may preferably mounted generally in a forward portion of football helmet FH.

Semiconductor sensor device 100 preferably comprises a flexible circuit board CB, sensor means 110 in the form of thermistor 111 connected thereto via lead 113, transmitter means 120, such as metal trace antenna 121 formed thereon and transmitter 123, memory means 130, such as EEPROM chip 131 connected thereto, determination means 140, such as microprocessor chip 141 connected thereto, and power supply means 150, such as lithium ion battery 151 connected thereto. Sensor means 110 is preferably mounted to football helmet FH via engagement of housing 115 to at least one of padding P and shell S such that thermally-conductive diaphragm 117 may contact the skin of a wearer during use.

As will be understood by those ordinarily skilled in the art, diaphragm 117 preferably exhibits beneficial properties such as corrosion-resistance, high durability, and flexibility. Diaphragm 117 may further be formed from a non-irritating and/or hypo-allergenic material to avoid discomfort during use. In a preferred embodiment, diaphragm 117 is formed from a synthetic rubber, such as SANTOPRENE. Encapsulant 119 is preferably formed from a thermally-conductive material; however, because encapsulant 119 is separated from a wearer's skin by diaphragm 117, encapsulant 119 needs only exhibit beneficial thermal conductivity, whereby thermistor 111 is effectively sealed therein, protected from shock, secured to diaphragm 117, and thermally connected to an exterior surface of diaphragm 117 in contact with a wearer. In a preferred embodiment, housing 115 is formed from polypropylene having a diameter of approximately ½ inch and a thickness of approximately ¼ inch.

Circuit board CB may be formed from a flexible semiconducting material, such as a polyimide sheet, or, alternatively, may be formed from conventional rigid materials, such as silicon or the like. In either form, circuit board CB preferably carries each of metal trace antenna 121, transmitter 123, EEPROM chip 131, microprocessor chip 141, and battery 151. In order to protect circuit board CB, and the a plurality of components thereon, coating 160 is formed completely thereover, whereby circuit board CB is sealed within coating 160 to prevent damage thereto from environmental conditions such as liquids, humidity, high temperature, shock, pressure, and the like. Coating 160 is preferably formed from a durable polymer material and is preferably molded over circuit board CB. In a preferred embodiment, circuit board CB is flexible, shock resistant up to at least approximately 120 g, and has a length of approximately 2 inches, a width of approximately 1 inch, and a thickness of approximately 0.2 inches. Transmitter 123 is preferably configured to output signals at a frequency of approximately 916.5 MHz, and is capable of receiving and transmitting signals at a distance of approximately 100 yards or more, point-to-point.

As mentioned briefly above, during use, diaphragm 117 is preferably disposed in thermal contact with an associated individual's skin, such as the associated individual's forehead, and conducts thermal energy to thermistor 111 via encapsulant 119. Thermistor 111 is preferably operable to output a signal, such as a resistance, indicative of a body temperature of the associated individual via lead 113. Microprocessor chip 141 is preferably operable to receive the output signal indicative of the body temperature of the associated individual via lead 113 and to cause transmitter 123 to wirelessly transmit a signal having temperature information corresponding to the associated individual's temperature and identification information. Battery 151 is preferably operable to provide electrical power to microprocessor chip 151, transmitter 123, EEPROM 131, and/or thermistor 111, as needed. In the preferred embodiment, thermistor 111 is operable to output a signal indicative of temperatures ranging from at least approximately 70 degrees Fahrenheit to approximately 140 degrees Fahrenheit, has an accuracy of ±1 degree Fahrenheit, and is capable of resolving temperature values to 0.1 degree Fahrenheit.

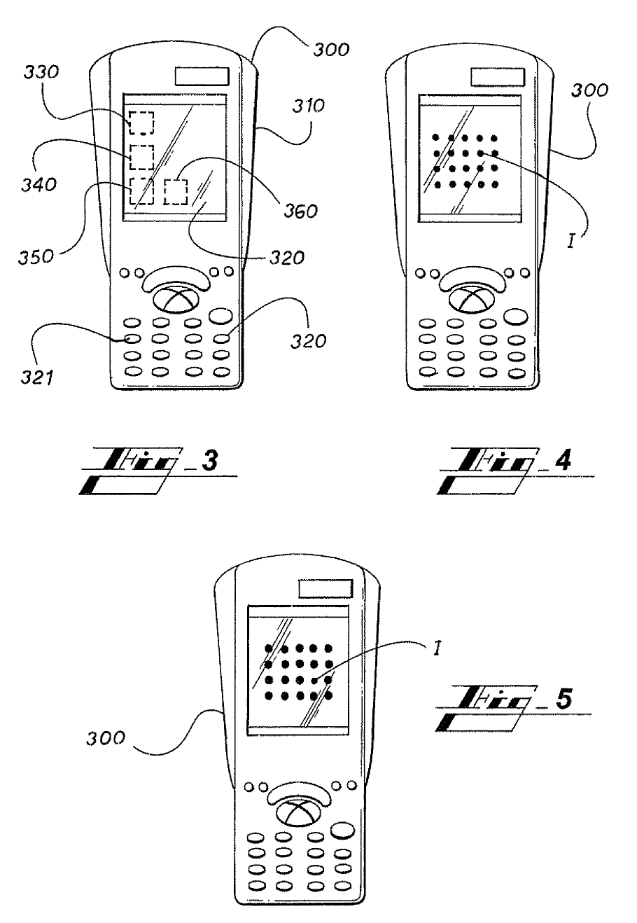

Referring now to FIG. 3, hand-held monitoring unit 300 preferably includes display device 310 for displaying information in the form of graphics, pictures, text, sound, or the like, input device 320 for inputting information and/or instructions, preferably via a computer program product, storage device 330 for storing information and/or at least one computer program product, processor device 340 for executing the computer program product(s) stored on storage device 330, power supply 350 for providing electric power to the components of hand-held interface unit 300, and transmitter/receiver 360 for wirelessly transmitting and/or receiving signals from one or more semiconductor sensor device 100. Monitoring unit 300 may be formed as a personal digital assistant, a dedicated portable device, a laptop computer, or the like. While hand-held monitoring device 300 formed as a dedicated portable device is preferred, any device capable of performing the functions described herein may be used, including a desktop computer or other stationary device. In the preferred embodiment, monitoring device 300 is formed as a wireless, hand-held, ruggedized, dedicated PDA that is water-resistant, shock-resistant, and durable.

Display device 310 is preferably formed as an LCD touch screen or other similar display device capable of displaying graphics such as pictures and/or text, and is used to display various information, such as high-temperature warning signals, athlete information, non-communication signals, low-battery signals, biological parameter information, or other information, to a user, such as a coach, trainer, supervisor, scout, parent, or the like. Display 310 is preferably controlled by processor means 340 and displays graphics generated thereby according to a computer program product stored on memory means 330. Thus, information generated by hand-held monitoring unit 300 may be communicated to a user via display 310. As will be understood by those ordinarily skilled in the art, display 310 may further include a speaker or other output device whereby such information may be communicated to the user. The speaker or other output device may be integral with, or wirelessly connected to, monitoring unit 300, such as a BLUETOOTH headset, or the like.

Input device 320 preferably includes a plurality of buttons 321 and touch-screen display device 310, each which may be used to navigate or select various options within the computer program product, or the like, and may also be used to enter information, such as into a database included in the computer program product. Additionally, or alternatively, input device 320 may include a microphone whereby monitoring device 300 may be voice-operated. Transmitter/receiver 360 may be formed as a card, such as a compact flash card that may be connected to hand-held monitoring unit 300 to allow hand-held monitoring unit 300 to wirelessly transmit signals and data to, and to wirelessly receive signals and data from, a plurality of semiconductor sensor devices 100. Preferably, transmitter/receiver 360 comprises a radio-frequency antenna for sending and receiving such signals and data, and is preferably controlled by the computer program product stored on memory means 330.

In use, and as illustrated in FIGS. 4-8, a plurality of semiconductor sensor devices 100, and thus a plurality of biological parameters associated with a respective plurality of individuals, may be monitored simultaneously using hand-held monitoring unit 300. The computer program product is preferably operable to cause an associated indication, such as colored icon I, to be displayed on display means 310 for each respective monitored individual such that the user may quickly ascertain information about the status of each monitored individual. The computer program product is preferably operable to display each icon I in one of a plurality of configurations, such as having different colors. A current status of a particular monitored individual may, thus, preferably be indicated by an associated one of the different configurations. For example, if a particular monitored individual is not in communication range with hand-held interface device 300, then icon I associated with such monitored individual may preferably be displayed in yellow. The icon I associated with a monitored individual whose associated semiconductor sensor device has failed or malfunctioned, such as due to damage, power loss, or which is no longer in contact with the monitored individual, may also be displayed in yellow, or in another selected color or pattern to indicate such status. Similarly, if monitoring device 300 determines, such as according to the method described below, that one or more biological parameter of a monitored individual exceeds a predetermined threshold, then the associated icon I may preferably be displayed in red, thereby warning the user of such condition. Additional conditions or status, either of the monitored individuals or of the respective associated semiconductor sensor devices 100, may similarly be monitored whereby different or additional warning signals may be communicated to the user.

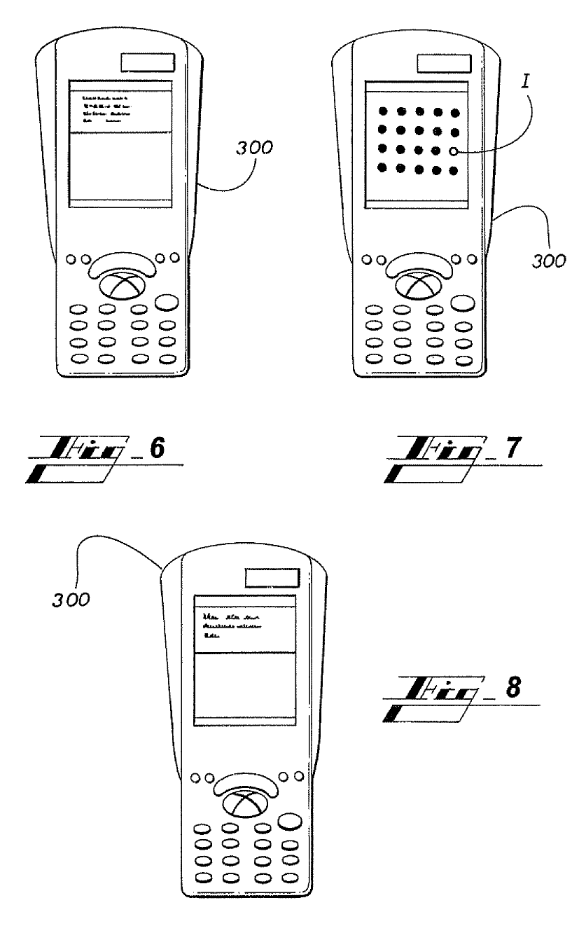

Optionally, the computer program product may be operable to display a list when one or more warning signal generated by monitoring device 300 remains unacknowledged. Thus, monitoring device 300 may function to display only those icons I associated with monitored individuals, or the semiconductor sensor devices 100 associated therewith, whose status is not normal, i.e. whose associated semiconductor sensor device is not functioning or whose monitored biological parameter has exceeded a predetermined threshold, such as a safety threshold. The computer program product is further operable to display additional information about the monitored individuals and/or associated semiconductor sensor devices 100 for which the warning signal was generated, such as a name, picture, jersey number, medical history or medical information, contact information, time last in communication, performance information, battery level, sensed parameter values, sensor device identification information, or other information. If desired, the user may select an icon I to obtain additional information pertaining to an associated monitored individual. The computer program product may be operable to prevent access to other functions until all warning signals have been acknowledged, such as by clicking on icon I for which the warning signal was generated, or which have been removed, such as when communication is reestablished. Preferably, all information associated with a monitored individual is stored in a database of the computer program product, and is accessible by the user, if desired. Only selected information is displayed upon the generation of a warning signal. Selecting an icon I preferably causes the display of FIG. 6 or 8 to be displayed to the user, wherein additional information may be accessed.

In a specific example, a football coach preferably begins by activating monitoring device 300, such as by manipulating a power switch, which may be formed as a button 321. The computer program product for monitoring individuals may then be executed, either automatically, such as when monitoring device 300 is a dedicated device, or by manipulating a button, icon, or the like. When the computer program product is executed, the coach may be required to provide login information that may be authenticated by the computer program product, such as by comparison to stored login information, in order to prevent unauthorized use of the computer program product. When the login information provided by the coach is accepted, the coach may be able to manage a database of information by viewing the information, modifying the information, adding new information, or the like.

If the coach desires to add a new entry into the database, the coach may activate an “add new player” process. The “add new player” process preferably prompts the coach to add information for each of a plurality of fields defined in the database, including a sensor device ID, a player's name, and the player's uniform number. Additional fields may additionally be included, and the coach may enter information pertaining to the player or the sensor device as desired. When the coach has completed the information entry, the coach may exit the “add new player” process. Similarly, the coach may modify existing information by activating a “modify player” process, or may delete the information of all fields associated with a player by activating a “delete player” process.

The computer program product preferably further allows the coach to begin monitoring, either automatically upon login, or upon activation of a “monitoring” process. The “monitoring process” preferably causes transmitter/receiver 360 to broadcast a “request signal” requesting a response from one or more semiconductor sensor device(s) 100. All semiconductor sensor devices 100 within range of the “request signal”, and which receive same via respective transmitter means 120, are preferably configured to respond by transmitting a respective “return signal” to monitoring device 300 having identification information and temperature information. Monitoring device 300 preferably receives each respective “return signal” and, based on the respective identification information and the temperature information, the computer program product causes a corresponding icon I to be displayed on display device 310 for each respective “return signal”. Each icon I is preferably displayed in a color indicating a status determined by the computer program product. For example, if the temperature information indicates that the temperature sensed by the sensor device is below a first “helmet on” threshold, the computer program product may determine that the associated helmet is not being worn by the associated player, and may cause the associated icon I to be displayed in yellow. If the temperature is above the first threshold, the associated icon I may be displayed in green. The computer program product is preferably configured to continue to transmit a “request signal” periodically, such as once every 15 seconds, once a minute, or the like, and to update a display based on return signals received (or not received, discussed in greater detail below) to indicate a current status of each respective associated player and/or sensor device 100.

The computer program product is preferably further configured to perform a determination process upon receipt of each return signal. The determination process preferably compares the identification information portion of the return signal to the identification information field of the database, and preferably converts the temperature information (which may be in any form) to a temperature value, and compares the temperature value with a mean value. If a difference between the temperature value and the mean value exceeds a predetermined threshold, such as 2 degrees Fahrenheit, then a warning signal is preferably generated by the computer program product that causes an icon associated with the player to be displayed in a red color. If the difference does not exceed the predetermined threshold, then the associated icon is preferably displayed in green. Although use of a mean value is preferred, it should be understood that the determination may be made by comparison of a temperature value derived from the temperature information to a predetermined temperature value. Similarly, the determination may be based whether the temperature value exceeds the predetermined value (compared with whether a difference exceeds a predetermined threshold).

If there is no mean value, such as when a “return signal” is the first signal received, then the computer program product preferably stores the temperature value determined from the “return signal”. The computer program product may preferably take the first temperature value received for each sensor device 100 for use in generating the mean value. The mean value may be generated by discarding the highest value, discarding the lowest value, and finding the numerical mean of the remaining values. The mean value may then be used for comparison with all “return signals” received, or the computer program product may generate a mean value for each player, or for selected groups of players, at least for the duration of the monitoring session (i.e. until the monitoring process is ended). Use of individualized mean values, at least for selected players, may allow the system to account for special needs or special risks for associated players. For example, if a player is known to have suffered from heat-related illness in the past, a special lower mean value may be used to ensure adequate warning. As will be understood by those ordinarily skilled in the art, the computer program product may be configured to generate the mean value as desired, and may require a minimum number of “return signals” and may complete the generation of the mean value upon receiving a predetermined number of “return signals.” Similarly, the mean value may be updated, continuously or periodically, or upon entry of an update mean value command by the coach or other user.

The computer program product preferably further maintains a list of all sensor device from which a response signal has been received, whereby if monitoring device 300 does not receive a “return signal” from one or more sensor device in the list after a predetermined number of “request signals”, then the computer program product may generate an out of communication warning signal for such unresponsive sensor device, and may cause the icon I associated therewith to be displayed in yellow. The computer program product may further store additional information, such as a log of all warning signals generated, a time of generation, whether the warning signal was acknowledged, and when the warning signal was acknowledged. If desired, the computer program product may further store temperature values for all players, or selected players, automatically, such as after a warning signal is generated, or upon activation of a log temperature feature by a user. All temperature values may be stored, along with time-stamp information, or, the computer program product may be configured to store only a predetermined number of values, such as the last 10 values derived from “response signals”. Thus, a log may be used to track the events occurring before, during, and/or after a warning signal was generated. Such log may preferably be used to refine the computer program product, such as by adjusting pre-determined threshold values, or other operating parameters of the system, or for use in diagnosing and/or treating a player.

In a preferred embodiment, the computer program product performs a confirmation process prior to generating a warning signal. The confirmation process preferably includes transmitting a plurality of “request signals” at a higher rate than the rate of “request signal” transmission of the monitoring mode, such as every 5 seconds, to confirm the persistence of the detected condition, such as excessive temperature difference from the mean or non-communication. Thus, the computer program product preferably avoids false warnings, yet provides confirmed warning signals in a timely fashion. The computer program product is preferably operable to generate the warning signal after the condition persists for a predetermined period of time, such as 30 seconds, or for a predetermined number of “response signals”, such as 6. During the confirmation process, only a sensor device for which a condition has been detected responds to the confirmation “request signals”, although it is contemplated that the rate of “response signal” transmission may be increased for all sensor devices upon the detection of warning condition for a single sensor device.

The monitoring process may, alternatively, be driven by each semiconductor sensor device 100, wherein each thermistor 111 preferably senses a temperature of an associated player, and outputs a signal having a value corresponding to the sensed temperature. Microprocessor 141 preferably continuously or periodically compares the value of the output signal to a predetermined threshold value in order to determine whether the athlete is becoming overheated and is, therefore, at an increased risk of suffering from dehydration, heatstroke, or other heat-related illness. The predetermined value may be stored in EEPROM 130 and may be adjustable by the coach or other user of the system, and the predetermined value is preferably calibrated such that the coach may input a desired predetermined core body temperature above which a warning signal is generated, and a calibrated threshold value is automatically stored in EEPROM 131, taking into account other factors, such as a conversion between skin temperature and core body temperature.

As an optional feature, the computer program product may enable the coach to monitor one or more groups of players, such as a group of defense players, a group of offense players, a group comprising a “first string”, a group comprising a “second string”, or the like. Such group monitoring feature may be enable by including a field in the database for each player in which a yes or no (or true or false) entry may be made, whereby the computer program product will cause an icon I to be displayed in an associated group field only if a yes (or true) entry is made in the field associated with the selected group. Thus, the coach may monitor all players within range, but may benefit from being able to monitor such players in two or more groups simultaneously, such as by special separation of associated icons I on display 310. The computer program product may further generate separate mean temperature values for each group. Thus, false warning signals may be avoided in certain circumstances, such as when a first group is performing a first activity, such as running sprints, while a second group is performing a second activity, such as discussing new plays, or the like. Such group monitoring may preferably further enable the coach, or a trainer or scout, or the like, to make decisions based on the status of members of a selected group. For example, the coach may define a group to monitor all players at a selected position, such as running back, and may decide, based on a comparison of the temperature values of the players, which player to put in the game for a particular play, such as a running play. Similarly, the coach may decide to call a passing play if the status of a group of receivers indicates no warnings when the group of running players are overheated. As will be understood by those skilled in the art, many different unique groups of players may be created and monitored simultaneously, wherein a selected player may be included in two or more groups.

The system of the present invention may, optionally, be sold as a package, or may be leased, particularly when used in an academic setting. Such a leasing or renting implementation preferably facilitates convenient updates to the computer program product, monitoring device, and/or sensor device, including maintenance and/or repair thereof. Preferably, however, updates for the computer program product and support for the computer program product, monitoring device, and sensor device are available via a wide area network, such as the Internet.

Although the present invention has been illustrated with the aid of a particular embodiment, i.e. an embodiment adapted for implementation into a football helmet, it is contemplated that the system and method may be implemented in a variety of applications without departing from the scope of the invention. For example, the system and method may be adapted for use in helmets used in other sports, such as lacrosse, hockey, baseball, or other sports, in other fields of endeavor, such as in hardhats, welding helmets, firefighter's helmets, protective helmets for law enforcement and/or military combat/training, or the like. Accordingly, the system may be implemented other types or equipment or apparel, such as in protective body pads, clothing, footwear, headwear, or other articles, including, but not limited to headbands, hats, caps, wristbands, socks, shoes, gloves, shirts, or the like.

Furthermore, semiconductor sensor device 100 may be a be formed as a non-contact sensor such as an IR thermometer, or may directly sense and/or measure the temperature of a part of the helmet, such as the padding, in order to estimate the temperature of the athlete. In that case, thermally conductive elements may be implemented to facilitate convenient sensing/measuring while allowing semiconductor sensor device to remain safely and comfortably mounted remotely from the athlete's skin. As mentioned above, different and/or additional sensors may be included. As an example, a pressure sensor may be included within housing 15 and may detect a pressure within housing 15. A pulse may cause the pressure within housing 15 to vary through interaction with diaphragm 17. The pressure information generated by the pressure sensor may then be used to monitor heart rate and/or blood pressure.

In other alternative embodiments, one or more sensor device 100 may be wired to a monitoring device and/or may be fixed in position, such as when used to monitor a temperature of a synthetic playing field surface. As a further alternative, the sensor device 100 may include alarm means, such as one or more illumination device, audible buzzer, or vibration means to alert a wearer (in addition to the user or the monitoring device 300) that a warning signal has been generated for the individual or the associated sensor device 100, whereby the wearer may take appropriate action, such as resting, or escaping from a dangerous environment.

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A system for monitoring at least one biological parameter of at least one monitored individual comprising:
a first sensor means for generating a first signal corresponding to a biological parameter of a first individual associated with said first sensor;
a first transmitter means operable to transmit said first signal;
receiver means for receiving said first signal transmitted by said transmitter means; and
interface means operable to display at least one of said first signal and an indication corresponding to said first signal.

2. The system of claim 1, further comprising a second sensor means for generating a second signal corresponding to a biological parameter of a second individual associated with said second sensor means and a second transmitter means operable to transmit said second signal, wherein said receiver means is further operable to receive said second signal, and wherein said interface means is further operable to display at least one of said second signal and an indication corresponding to said second signal.

3. The system of claim 2, wherein each of said first signal and said second signal comprise respective biological parameter information and identification information.

4. The system of claim 1, wherein said first transmitter means transmits said first signal in a wireless format.

5. The system of claim 1, wherein said interface means displays an indication corresponding to said first signal.

6. The system of claim 5, wherein said indication indicates a status of at least one of said first sensor means and the first individual.

7. The system of claim 6, wherein said status is a temperature status, and wherein said temperature status is determined by comparison of a biological parameter value with a predetermined threshold value.

8. The system of claim 7, wherein said comparison comprises a determining a difference between said biological parameter value and a mean biological parameter value, and comparing the difference to a predetermined threshold difference value.

9. A method of monitoring at least one biological parameter of at least one individual comprising the steps of:
sensing a first biological parameter of a first individual;
generating a first signal based on said sensing of the first biological parameter of the first individual;
transmitting the first signal to a remote receiver; and
displaying at least one of the first signal and an indication corresponding to the first signal to monitor the first biological parameter of the first individual.

10. The method of claim 9, wherein the first biological parameter is a temperature.

11. The method of claim 9, further comprising the steps of sensing a first biological parameter of a second individual, generating a second signal based on said sensing of the first biological parameter of the second individual, transmitting the second signal to the remote receiver, and displaying at least one of the second signal and an indication corresponding to the second signal to monitor the first biological parameter of the second individual.

12. The method of claim 9, further comprising the steps of determining a first biological parameter value based on biological parameter information of the first signal, and comparing the first biological parameter value to a first predetermined value.

13. The method of claim 12, wherein the step of comparing the first biological parameter value comprises subtracting the first predetermined value from the first biological parameter value to generate a first deviation value.

14. The method of claim 13, further comprising the step of generating a warning signal if the first deviation value exceeds a first deviation threshold value.

15. The method of claim 13, wherein the first predetermined value comprises a mean biological parameter value.

16. The method of claim 15, wherein the mean biological parameter value is based on a plurality of biological parameter values determined from a plurality of signals received from a plurality of respective individuals.

17. The method of claim 14, wherein the indication corresponding to the first signal is the warning signal.

18. A temperature monitoring system for monitoring a respective temperature of a plurality of individuals comprising
a first thermistor operable with a first individual and a first radio-frequency transmitter; and
a monitoring device,
wherein said first thermistor is operable to output a first signal indicative of a sensed temperature of the first individual, wherein the first radio-frequency transmitter is operable to transmit the first signal to the monitoring device, and wherein the monitoring device is operable to display a first indication to a user, said first indication corresponding to a status of at least one of the first individual and said first radio-frequency transmitter.

19. The system of claim 18, further comprising a second thermistor operable with a second individual and a second radio-frequency transmitter, wherein said second thermistor is operable to output a second signal indicative of a sensed temperature of the second individual, wherein the second radio-frequency transmitter is operable to transmit the second signal to the monitoring device, and wherein the monitoring device is operable to display a second indication to the user, said second indication corresponding to a status of at least one of the first individual and said second radio-frequency transmitter

20. The system of claim 18, wherein said first indication comprises a first warning signal, wherein said first warning signal is generated when a temperature value based on the first signal deviates from a mean temperature value by an amount greater than a predetermined deviation threshold value.
